(19) United States
(12) Patent Application Publication
(10) Pub. No.: US 2013/0316823 A1
(43) Pub. Date: Nov. 28, 2013

(54) SEAFARING GAMES

(71) Applicants: Shaul Peled, Pardes Hana-Karkur (IL); Refael Amit Cohen, Yavneh (IL)

(72) Inventors: Shaul Peled, Pardes Hana-Karkur (IL); Refael Amit Cohen, Yavneh (IL)

(21) Appl. No.: 13/898,494

(22) Filed: May 21, 2013

Related U.S. Application Data
(60) Provisional application No. 61/649,940, filed on May 22, 2012.

(51) Int. Cl. A63F 13/00

(52) U.S. Cl. CPC A63F 13/00
USPC 463/31

(57) ABSTRACT

A seafaring game comprising: a virtual environment comprising a sailing region coincident with a region of a body of water; at least one navigation rule for navigating a sailboat in the virtual environment; and at least one game rule that defines an interaction between a first sailboat navigating the virtual environment and a second sailboat navigating the virtual environment and how to gain advantage for winning the game responsive to the interaction.

### RELATED APPLICATIONS

The present application claims the benefit under 35 U.S.C. 119(e) of U.S. Provisional Application 61/649,940 filed on May 22, 2012, the disclosure of which is incorporated herein by reference.

### TECHNICAL FIELD

Embodiments of the invention relate to sailing games played on the sea.

### BACKGROUND

Sailing games in which sailing boats or yachts compete are generally relatively complicated to set up and manage because they typically require distributing and anchoring physical props, such as buoys to mark sailing legs and delineate allowed or disallowed sailing areas, and positioning watch boats and crews to monitor the sailing games.

### SUMMARY

An aspect of an embodiment of the invention relates to providing a “seafaring” game and a virtual game environment for a body of water in which boats, sailing boats and/or yachts, hereinafter generically referred to as “sailboats”, on the water are sailed to engage in the seafaring game. A seafaring game in accordance with an embodiment of the invention, is relatively easily and rapidly set up and organized because it may not involve placement of physical props or referee boats, in the body of water.

In an embodiment of the invention, a computer system, hereinafter also referred to as a “game server”, comprises an executable program code that provides game constraints and/or conditions that define and manage the seafaring game and a virtual environment in which the game is played. Coordinates of real time locations of each of the sailboats participating in the game are determined and transmitted to the game server by a mobile terminal on board the sailboat that is configured to provide real time coordinates of the mobile terminal location and thereby of the location of the sailboat on the body of water and in the virtual game environment. The game server, executing the instruction set, uses the locations of the sailboat to generate and/or update a real time graphical game display of the seafaring game that is provided for presentation, optionally on a display screen of the mobile terminal, to interface a sailing crew of the sailboat with the game. The game display optionally shows a representation of the virtual game environment and environment features relevant to play of the seafaring game and icons representing the participating sailboats at locations of the virtual game environment shown in the game display that correspond to the actual locations of the sailboats on the water. The sailing crew of a participating sailboat may sail the sailboat responsive to the sailboat's location in the game display and features of the virtual game environment shown in the display.

Optionally, in addition to location coordinates, the game server receives signals from the mobile terminal indicative of actions undertaken by crew members of a sailboat during game play and uses the signals to determine status of progress of the game. For example, in a “shoot-em-up” seafaring game in accordance with an embodiment of the invention, as described below, the game server may receive signals indicating when a crew member of the sailboat shoots at another sailboat in the game and/or under what sailing and sailboat conditions shooting is performed.

In an embodiment of the invention, the game server may comprise a single computer or be a distributed system having components and/or executable program code located in different servers, and may be partially or completely based on access to servers via the internet, that is, partially or completely “cloud based”. The mobile terminal that provides real world geographical locations of a sailboat participating in the seafaring game may, by way of example, be a smart phone, personal digital assistant (PDA), laptop, workbook, or on-board computer configured to determine its location using the global positioning system (GPS) location technology or assisted global positioning satellite (A-GPS) location technology. A-GPS location technology refers to determining positions by GPS assisted by triangulation techniques provided by a mobile telephone network or by a dead reckoning inertial guidance system.

Constraints and/or conditions that the game server provides for a given seafaring game may for example, define how close a first sailboat participating in the seafaring game may approach a second sailboat participating in the seafaring game to enable the first sailboat to engage the second boat in a particular interaction, acquire game points, or win the seafaring game. The game server may establish virtual boundaries and regions on the body of water that affect navigation of the sailboats during play of the seafaring game or establish virtual environment features that may be used to affect progress of play. For example, boundaries may delineate a region or regions of the body of water within which the sailboats must remain during play of the seafaring game if they are not to be penalized by loss of points or a requirement to sail a detour to reach a particular location on the body of water. Virtual environment features may comprise safe harbors where a participant can temporarily seek refuge from play and hide, or provisioning docks for acquiring game assets.

In an embodiment of the invention, a seafaring game, hereinafter referred to as “Catch-Me-If-You-Can”, provides a game environment having virtual boundaries on a body of water that define a closed sailing circuit. First and second sailboats sail around the circuit in a same clockwise or counterclockwise direction from diametrically opposite starting positions on the circuit to chase and catch one the other from behind. The sailboat that first reaches within a given distance of the other from behind wins the game. A single crew may sail alone on a path in order to improve the crew's sailing skills, it may also compete against “ghost” boats generated by the system, or against the clock.

A seafaring game, hereinafter referred to as, a “Sea-Slalom”, in accordance with an embodiment of the invention delineates a set of virtual boundaries for a game environment that define a closed or open end sailing path on a body of water. The path is sailed by competing sailing crews and their sailboats to determine which crew and sailboat can sail the path, generally one following the other, in a least time with a minimum number of deviations from the sailing path. A single crew may sail alone on a path in order to improve the crew's sailing skills.

A seafaring game, hereinafter referred to as, “Engagement at Sea”, in accordance with an embodiment of the invention, defines characteristics and constraints for a sea battle “shoot-em-up” game, in which opposing armadas of at least one sailing ship engage in a virtual sea battle. “Engagement at Sea” provides a game display that enables a given participating sailing crew sailing a sailboat in one of the armadas to select a sailboat in the other armada as a target for shelling. Shelling the selected target sailboat may be performed by interacting with the game display using any of various methods known in the art. For example, a joy stick and/or keyboard may be used to interact with the game display to select and shell a target sailboat. If the game display is shown on a touch screen the display may be touched to select and shell the target sailboat. Engagement at Sea also defines rules for determining whether a shelled sailboat is hit and optionally how much damage the sailboat sustains if it is hit.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A-1E show schematic wireframes of a game display for the seafaring game Catch-Me-If-You-Can which are displayed at different stages of the game on a screen of a mobile terminal on board a sailboat participating in the game, in accordance with an embodiment of the invention;

FIG. 2 schematically shows a wireframe of a game display for the seafaring game, Sea-Slalom, in accordance with an embodiment of the invention; and

FIG. 3 schematically shows a wireframe of a game display for the seafaring game, Engagement at Sea, in accordance with an embodiment of the invention.

### DETAILED DESCRIPTION

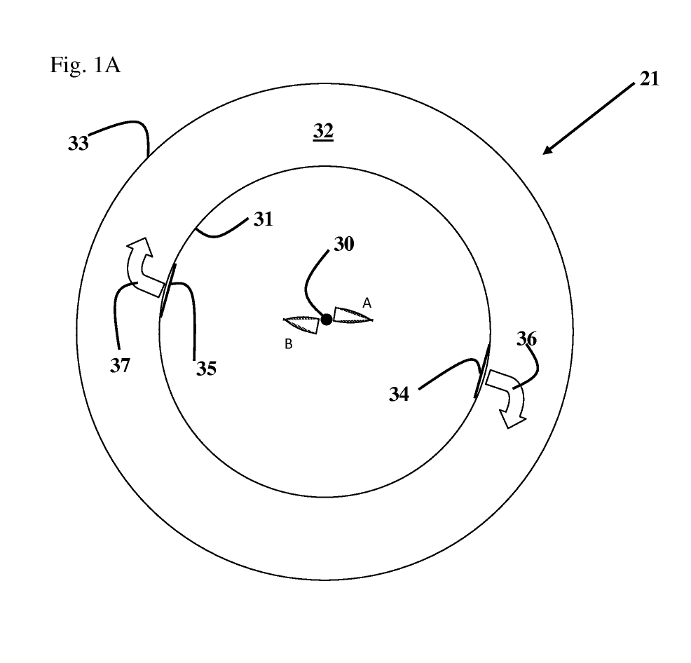

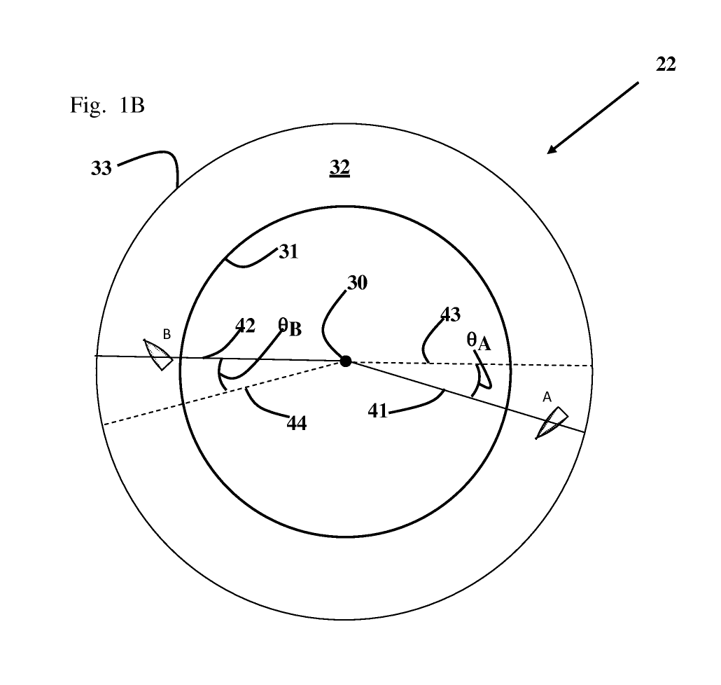

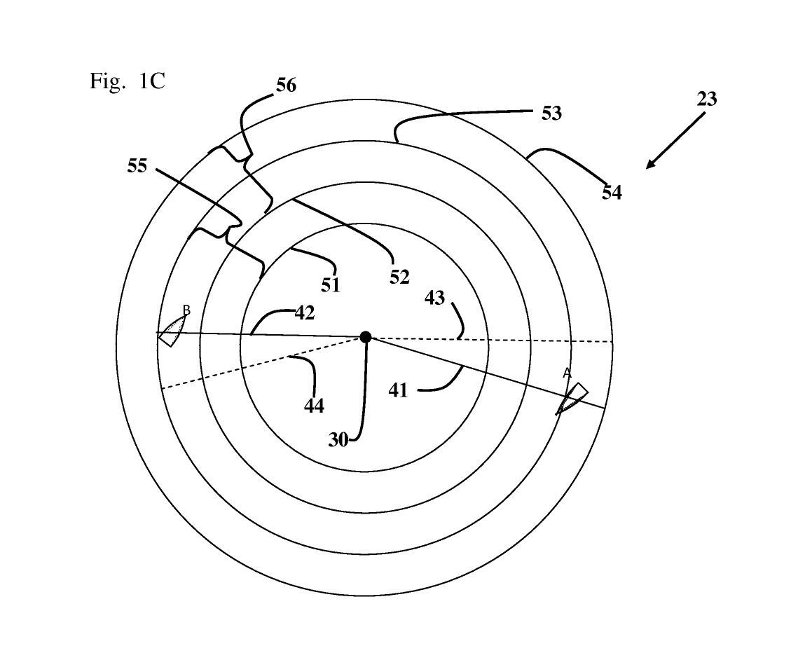

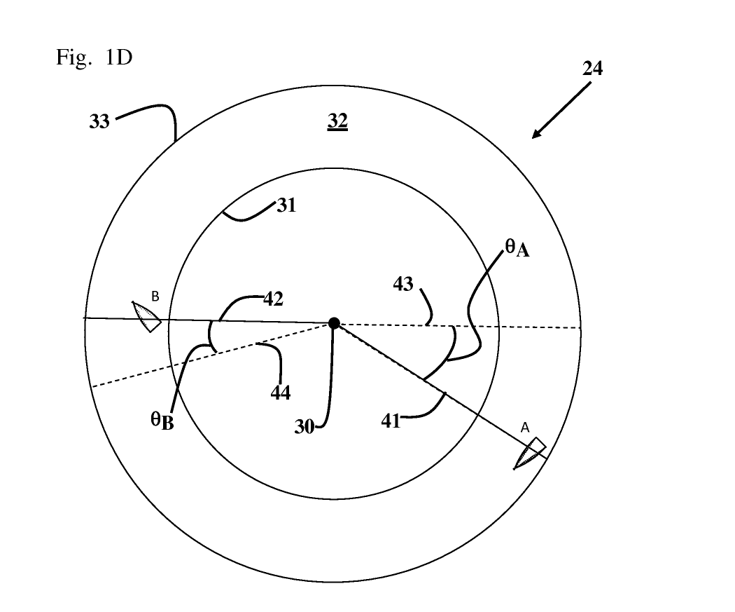

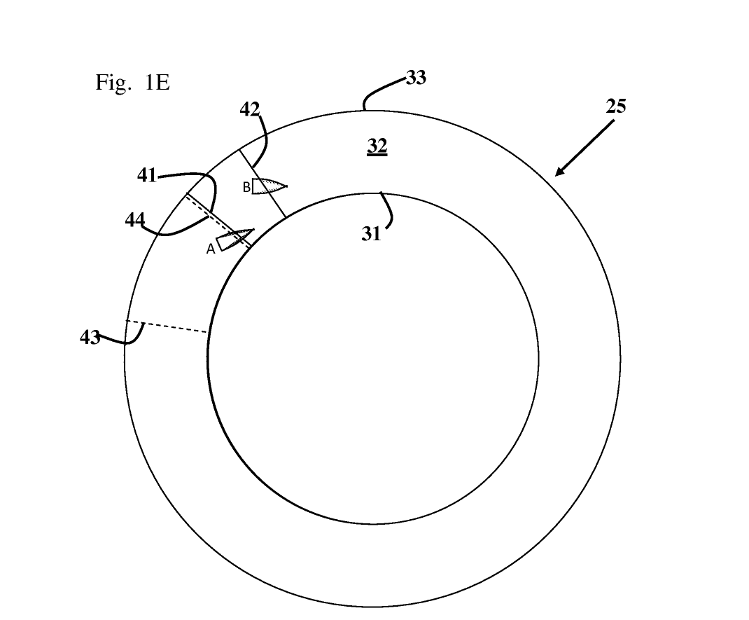

FIGS. 1A-1E show schematic wireframes of a game display for the seafaring game Catch-Me-If-You-Can, which are displayed at different stages of the game on a screen of a mobile terminal onboard a sailboat participating in the game, in accordance with an embodiment of the invention. The game, which may simultaneously be played by more than two sailing crews and their sailboats, is schematically shown in the wireframes by way of example being played on a body of water by two sailboats represented by icons labeled “A” and “B” in the figures. Optionally, the game server provides a virtual environment for playing the game comprising a circular sailing circuit. In an embodiment of the invention, the game server provides the wireframes, or other images showing progress of play of Catch-Me-If-You-Can, for display on spectator video screens and TVs, such as may optionally be found in harborside bars or restaurants along the shores of the body of water.

FIG. 1A schematically shows a wireframe 21 at a time at which the game of Catch-Me-If-You-Can begins, in accordance with an embodiment of the invention. Sailboats A and B have just passed by each other sailing in opposite directions and the game server (not shown), which is receiving locations for each of the sailboats from their respective onboard smart mobile terminals (not shown) shows icons labeled A and B in wireframe 21 at positions in the wireframe corresponding to the locations received from the mobile terminals. The game server has determined a region 30 of closest approach of the sailboats responsive to the locations of sailboats A and B as they passed each other and has provided a virtual environment for playing the game. Optionally, the virtual game environment comprises a circular sailing circuit defined as a region 32 of the body of water between concentric inner and outer circular boundaries, 31 and 33 respectively, which have a common center located substantially at closest approach region 30.

Sailboats A and B are required to enter sailing circuit 32 by sailing respectively through “gates” 34 and 35 indicated on inner boundary 31. Each sailboat A and B, upon passing through its assigned gate 34 or 35 is optionally required to turn in a direction indicated by block arrows 36 and 37 respectively in wireframe 21, and sail clockwise around sailing circuit 32 to attempt to catch the other sailing boat.

FIG. 1B schematically shows a wireframe 22 at a time just after each sailboat A and B has entered sailing circuit 32 and is turning to sail clockwise around the sailing circuit. Solid radial lines 41 and 42 indicate angular locations of sailboats A and B respectively. A dashed line 43, hereinafter also referred to as a “Backline” 43, rotated counterclockwise from line 41 by an angle θ_{A} defines a “catch me” boundary which sailboat B has to reach to catch sailboat A and win the Catch-Me-If-You-Can seafaring game. Similarly, a dashed Backline 44 rotated counterclockwise from line 42 by an angle θ_{B} defines a catch me boundary which sailboat A has to reach to catch sailboat B and win the seafaring game.

Optionally, at the beginning of Catch-Me-If-You-Can, angles θ_{A} and θ_{B} are equal. In an embodiment of the invention angles θ_{A} and θ_{B} may be unequal or time dependent to provide for a suitable handicap for one of sailboats A and B. For example, if sailboat B is less maneuverable, slower than sailboat A, or a crew of sailboat B less skilled than a crew of sailboat B, θ_{A} may be larger than θ_{B} at the beginning of the game or θ_{A} may increase with time.

FIG. 1C shows a schematic wireframe 23 illustrating another way to provide a handicap for one of sailboats A and B, in accordance with an embodiment of the invention. In FIG. 1C, sailboat B is assumed to be slower or less maneuverable than sailboat A. To compensate for the relative disadvantage of sailboat B, the game server assigns a sailing circuit 55 located between circular boundaries 51 and 53 that has a smaller inner radius than an inner radius of a sailing circuit 56, which is located between boundaries 52 and 54 and assigned to sailboat A.

During play of Catch-Me-If-You-Can, sailboat A sails outside of sailing circuit 32 shown in FIG. 1B. The game server penalizes sailboat A for leaving sailing circuit 32 by having its angle θ_{A} increased to move Backline 43 further behind sailboat A to make it easier for sailboat B to catch sailboat A. FIG. 1D shows a schematic wireframe 24 for which θ_{A} is increased to penalize sailboat A.

Despite its penalty, sailboat A manages to reach Backline 44 of sailboat B, and win the Catch-Me-If-You-Can game. FIG. 1E shows a schematic wireframe 25 at a time at which sailboat A crosses Backline 44 and wins the game.

In some embodiments of the invention Catch-Me-If-You-Can assigns a “Frontline” (not shown) to each sailboat A and B in addition to its respective Backline 43 and 44. The Frontline assigned to sailboat A is rotated relative to radial line 41 so that it lies on a side of radial line 41 opposite to that of Backline 43. Backline 43 and its associated Frontline define a sailing sector for sailboat A. A region delimited by Backline 44, the Frontline, and inner and outer circular boundaries 31 and 33 define a substantially trapezoidal “sailing zone” for sailboat A. Similarly, the Frontline assigned to sailboat B is rotated relative to radial line 42 so that it lies on a side of radial line 42 opposite to that of Backline 44. Backline 44 and its associated Frontline define a sailing sector for sailboat B and together with inner and outer boundaries 31 and 33, a substantially trapezoidal sailing zone for sailboat B.

As long as sailboat A and sailboat B sail within sailing circuit 32, their respective sailing zones move with them. If a sailboat A or B leaves sailing circuit 32, its respective sailing zone ceases to “track” movement of the sailboat and optionally remains stationary at a location at which it was located when the sailboat exited the sailing zone. The sailboat may disqualified from play or may be considered to be “offside” and does not resume competition until it sails back to its sailing zone.

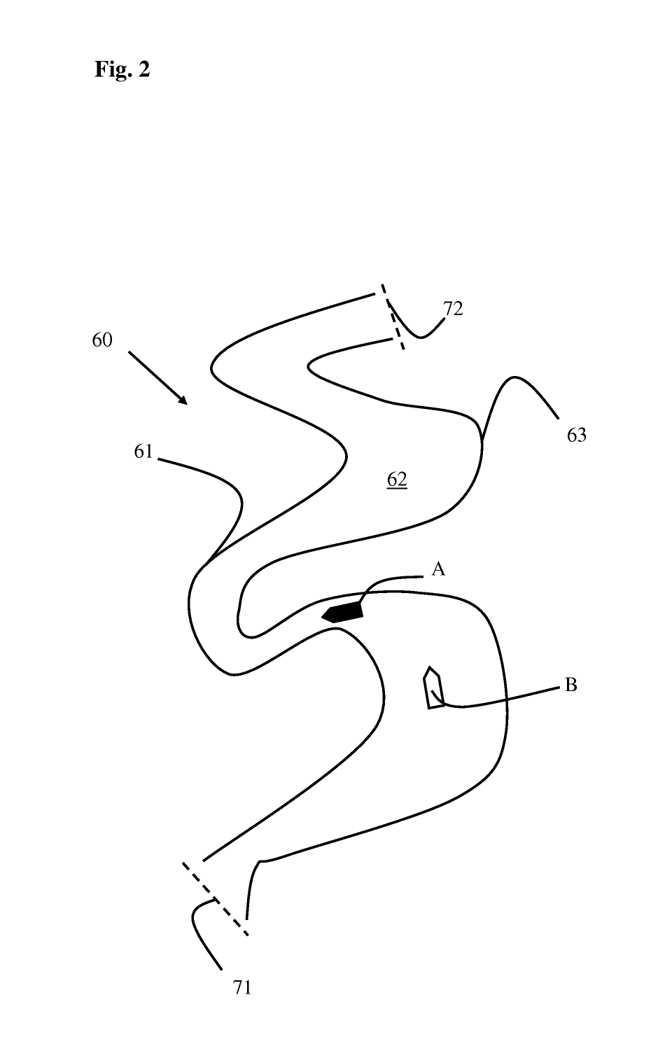

FIG. 2 shows a schematic wireframe 60 generated by a game server (not shown) during a seafaring game of Sea-Slalom that is shown on mobile terminals (not shown) on board sailing boats participating in the game, in accordance with an embodiment of the invention. Wireframe 60 shows a virtual environment generated by the game server that includes first and second virtual boundaries 61 and 63 that define a “slalom” sailing path 62. A sailing crew playing the game is required to attempt to sail a sailboat from a start line 71 to a finish line 72 of slalom sailing path 62 in a fastest sailing time while remaining between virtual boundaries 61 and 63.

By way of example, wireframe 60 shows icons labeled A and B representing two sailboats playing Sea-Slalom and navigating slalom sailing path 62. A slalom game score for a sail by each sailboat A and B over slalom path 62 is optionally determined as a function of the boat's sailing time over the slalom path increased responsive to a number of times the boat has breached virtual boundary 61 or 63 during the sail. A crew achieving a fastest time corrected for infractions of virtual boundaries 61 and 63 wins the game.

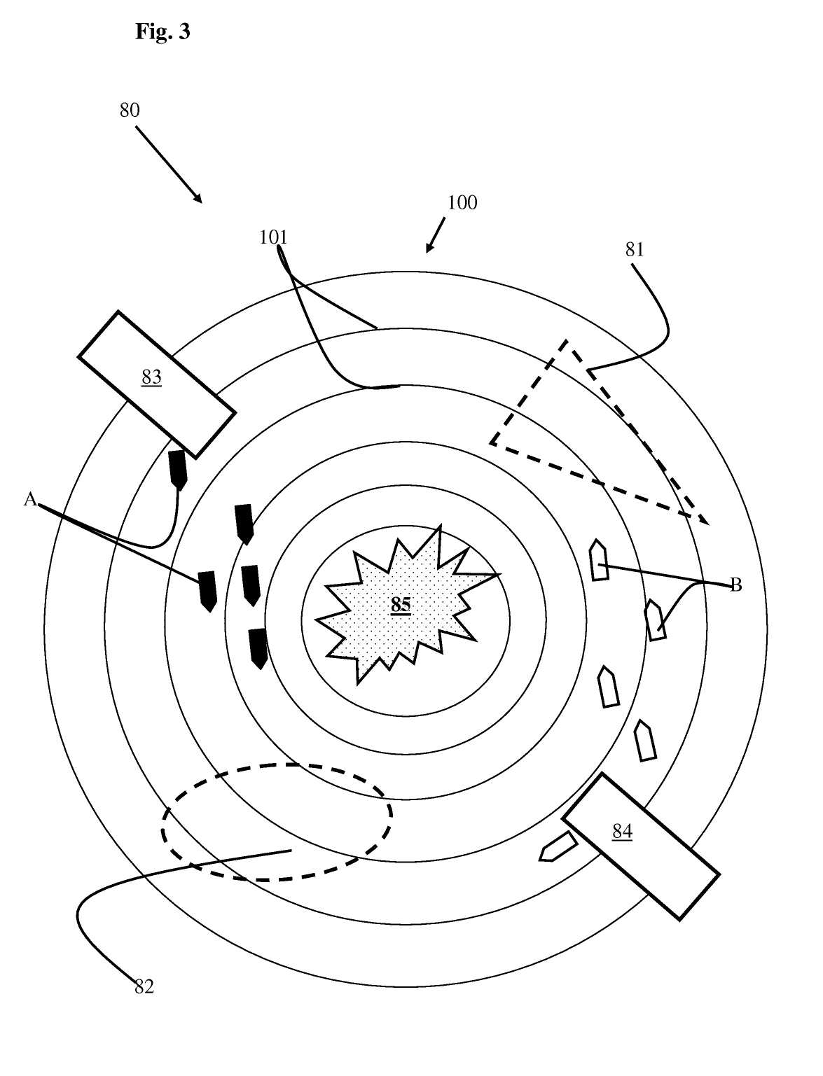

FIG. 3 shows a schematic wireframe 80 generated by a game server (not shown) during a seafaring game of Engagement-at-Sea that is shown on mobile terminals (not shown) onboard sailing boats participating in the game, in accordance with an embodiment of the invention.

Wireframe 80 optionally shows a virtual environment 100 for a region of a body of water (not shown) in which Engagement-at-Sea is being played, optionally overlaid by a radar screen grid of circles 101, in accordance with an embodiment of the invention. By way of example, two opposing “armadas” of sailboats, an armada of sailboats represented by black icons labeled A, and an armada of sailboats represented by white icons labeled B, are playing the game. During play each armada attempts to destroy the other armada by shelling the other armada's sailboats.

Virtual environment 100 optionally comprises a region 85 of shoals, safe regions 81 and 82, and black and white provisioning docks 83 and 84 respectively. Safe regions 81 and 82 are optionally triangular and elliptical respectively. Black and white sailboats A and B are equipped with various virtual weapons (not shown) such as virtual naval artillery of various caliber and/or virtual naval missiles, for shelling sailboats in the opposing armada. A sailboat in a safe region 81 or 82 cannot be damaged by shelling from a sailboat of the opposing armada. A black sailboat may replenish stores of artillery shells by docking at black provisioning dock 83. Similarly, a white sailboat may replenish stores of artillery shells by docking at provisioning dock 84. A sailboat drifting or sailing into shoal region 85 is destroyed and eliminated from the game.

In an embodiment of the invention the game server may provide a plurality of different selectable game display configurations for a real time display of the status of a game of Engagement-at-Sea. For example, a crew member of a participating sailboat may choose between two game display modes: a static mode in which a map of the virtual environment in which Engagement-at-Sea is being played is always oriented to the North; and a dynamic mode in which the crew member's sailboat is at a center of a map of the virtual environment and the display orientation is constantly changing substantially according to the heading of the sailboat.

In an embodiment of the invention a first sailboat being targeted for shelling by a second sailboat is “locked” when a crew member of the second sailboat clicks on an icon in the game display representing the first sailboat. Optionally, the crewmember fires on a locked target sailboat, by clicking a ‘Fire’ button in the display. Optionally, prior to shelling the first sailboat the crew member may select a “pre-fire display” comprising indications of: the locked target, number of remaining shells, and quality of aim. A click on a range button in the pre-fire display may give a graphical indication of effective artillery range. Following shelling the first sailboat, the crew member may select a “post-fire display” that provides an assessment of damage inflicted on the first sailboat.

Any of various methods may be used to determine how successful shelling by the first sailboat is effective in causing damage to the second sailboat. For example, each sailboat engaged in Engagement-at-Sea may begin the game with a damage count equal to zero and each time damage is inflicted on a sailboat by shelling from another sailboat the damage count is increased. An amount that the damage count of the second sailboat is increased by shelling from the first sailboat may be a function of a type of ordnance fired by the first sailboat and where the ordnance hit the sailboat. If the damage count for a sailboat reaches a predetermined maximum the sailboat may be considered to be sunk and no longer a participant in the game.

Optionally, a measure of how effective shelling of the first boat by the second boat is may be determined responsive to at least one of: a range between the first and second sailboats, stability of the first and second boat at the moment of shelling the second boat, relative velocities of the sailboats and amount of damage the second boat has sustained prior to shelling the first boat.

By way of example, in an embodiment of the invention, a successful shelling of, a “hit” on, a first sailing boat by a second sailing boat is determined responsive to the following factors.

1) A range factor:
The range factor may be a function of a distance, a “range”, between the first and second sailing boats, and upper and lower bounds, “minRange” and “maxRange” respectively, for the range. Optionally, the range factor is defined in accordance with the following conditions:

range factor=0 if range<minRange, or range>maxRange;

otherwise: Range factor=0.5+(maxRange−range)/2*(maxRange−minRange).

2) A boat stability factor for each of the first and second sailboats. The stability factor for a sailboat is determined substantially for a firing time at which the second boat fires at the first sailboat. Optionally the stability factor is equal to a value for r² for a linear regression of a last ten location points (fixes) for the sailboat acquired prior to the firing time.

3) An aim factor:
In an embodiment, for each pair of consecutive fixes used to determine the stability factor for the first and second sailboats a displacement vector equal to the difference between the two fixes is determined Let each displacement vector between a j-th fix for a first or second sailboat and an immediately subsequent (j+1) fix for the sailboat be referred to as d_{n,j}, where the index n is equal to 1 or 2 to indicate the first or second sailboat respectively. The index j is assumed to increase from 1-9 with a lower index referring to a fix earlier than a fix referenced by a larger index j. An aim factor may be determined to be equal to a variance σ² determined for the difference vectors (d_{1,j}−d_{2,j}), 1≦j≦9.

4) Hit correction factors:
4.1) Stability correction: if the first sailboat stability factor is greater than or equal to 0.7, the range factor is increased by 50%.
4.2) Damage factor—a damaged sailboat's aim quality decreases with increase in damage of the sailboat.

5) Hit probability=Range factor*firing boat stability factor*target boat stability factor*aim factor.

Whereas in the above discussion real sailboats playing a seafaring game in a virtual environment in accordance with an embodiment of the invention are described as playing against real sailboats in the environment, practice of the invention is not limited to real sailboats playing against real sailboats. For example, a game server in accordance with an embodiment of the invention may provide a virtual game environment for a seafaring game, and in addition, at least one virtual sailboat in the game environment that participates in the game. Optionally, the game server controls the at least one virtual sailboat.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A seafaring game comprising:
a virtual environment comprising a sailing region coincident with a region of a body of water;
at least one navigation rule for navigating a sailboat in the virtual environment; and
at least one game rule that defines an interaction between a first sailboat navigating the virtual environment and a second sailboat navigating the virtual environment and how to gain advantage for winning the game responsive to the interaction.

2. A seafaring game according to claim 1 wherein the virtual environment comprises at least one boundary that delineates the sailing region.

3. A seafaring game according to claim 2 wherein the at least one boundary comprises two substantially concentric circle and the sailing region comprises is a region between the concentric circles.

4. A seafaring game according to claim 3 wherein the at least one navigation rule comprises a rule that the first and second sailboats sail within the sailing region.

5. A seafaring game according to claim 4 wherein the at least one navigation rule comprises a rule that stipulates that if a sailboat of the first or second sailboat breaches the at least one boundary, the sailboat is sanctioned with a penalty that reduces a probability that the sailboat can win the game.

6. A seafaring game according to claim 4 wherein the at least one navigation rule comprises a rule that defines a sailing zone for each sailboat that moves with the sailboat as long as the sailboat sails within the sailing region and stipulates that the sailing zone ceases to move with the sailboat if the sailboat breaches the sailing region, and that the sailboat is disqualified from play or determined to be offside and stayed from play until the sailboat sails back to its sailing zone.

7. A seafaring game according to claim 3 wherein the at least one game rule requires that that the first and second sailboats chase each other by sailing one to follow the other within the sailing region.

8. A seafaring game according to claim 7 wherein the at least one game rule comprises a rule that a sailboat of the first and second sailboat to first sail to within a defined distance of the stern of the other sailboat wins the game.

9. A seafaring game according to claim 8 wherein the defined distance is an azimuthal distance.

10. A seafaring game according to claim 9 wherein the at least one game rule comprises a rule that assigns a handicap to one of the first and second sailboats.

11. A seafaring game according to claim 10 wherein the handicap is a handicap provided for the slower of the first and second sailboats that comprises allowing the slower of the sailboats to sail a shorter path than the faster of the sailboats to sail to within a predetermined distance of the stern of the faster of the sailboats.

12. A seafaring game according to claim 11 wherein the handicap is a handicap provided for the slower of the first and second sailboats that comprises defining the predetermined distance from the stem of the faster of the first and second sailboats as an increasing function of time.

13. A seafaring game according to claim 1 wherein the at least one game rule provisions each of the first and second sailboats with virtual weapons operable to fire ordnance to inflict virtual damage on the other of the first and second sailboats
and the at least one game rule defines how to determine if ordnance fired by one of the first or second sailboats at the other of the first and second sailboats hits the other sailboat.

14. A seafaring game according to claim 13 wherein the first and second sailboats are members respectively of first and second fleets of sailboats participating in the game and the at least one game rule provisions a plurality of sailboats in each of the fleets with virtual weapons operable to inflict virtual damage on sailboats of the other fleet.

15. A seafaring game according to claim 14 wherein the at least one game rule comprises a rule that determines which of the fleets wins the game responsive to an amount of damage inflicted by each of the fleets on the other of the fleets.

16. A seafaring game according to claim 1 wherein a sailboat participating in the game is a virtual sailboat.

17. A system for playing a seafaring game, the system comprising:
a computer system comprising executable program code that:
defines a virtual environment comprising a sailing region coincident with a region of a body of water;
comprises at least one navigation rule for navigating a sailboat in the virtual environment; and
comprises at least one game rule that defines an interaction between a first sailboat navigating the virtual environment and a second sailboat navigating the virtual environment and how to gain advantage for winning the game responsive to the interaction;
a mobile terminal in each of the first and second sailboats that comprises a display screen and is configured to transmit real time locations of the sailboat on the body of water to the computer system during game play;
wherein the computer system is configured to generate a real time graphical display of the game status on the display screen of each mobile terminal responsive to the locations of the first and second sailboats.

18. A system according to claim 17 wherein the sailing region is bounded by at least two substantially concentric circles and the at least one game rule requires that that the first and second sailboats chase each other by sailing one to follow the other within the sailing region.

19. A system according to claim 18 wherein the at least one game rule comprises a rule that a sailboat of the first and second sailboat to first sail to within a predetermined azimuthal angular distance of the stern of the other sailboat wins the game.
